(19) United States
(12) Patent Application Publication
(10) Pub. No.: US 2009/0032590 A1
(43) Pub. Date: Feb. 5, 2009

(54) Location, orientation, product and color identification apparatus, system and method for the blind or visually impaired

(76) Inventor: Billy D. Hopkins, Portland, OR (US)

Correspondence Address: ATER WYNNE LLP, 222 SW COLUMBIA, SUITE 1800, PORTLAND, OR, 97201-6618, US

(21) Appl. No.: 11/888,952

(22) Filed: Aug. 2, 2007

(51) Int. Cl. G06F 19/00

(52) U.S. Cl. 235/385

(57) ABSTRACT

A radio frequency identification (RFID) enabled assistive device, system and method for blind or visually impaired (B & VI) persons. A device typically includes at least partially within a hand-operated housing structure a RFID scanner capable of interrogating a surrounding environment of the presence of one or more RFID tags, a RFID decoder capable of converting a received RFID signal to an audio signal, and an audio output device configured to produce a user-audible output including information derived from a received RFID signal. Additionally and/or alternatively, a vehicle can be configured with an RFID scanner, decoder, and audio and/or visual output device to warn an operator of the vehicle of the proximity to a B & VI person possessing an RFID tag. Additionally, a handheld scanning device enabling B & VI persons to obtain information encoded at a barcode label and information related to the color of a scanned item, for example at the shelves of a store or other commercial or other environment. Such scanning device typically includes at least a barcode scanner, a color scanner, a microprocessor, and an audio output device.

### RELATED APPLICATIONS

This continuation-in-part application claims the benefit of priority to the prior filed, co-pending, non-provisional United States patent application 20060108426, filed Nov. 23, 2004.

### FIELD OF THE INVENTION

The invention relates generally to assistive devices for blind or visually impaired persons. In particular, the invention relates to devices and methods of their use by perambulating blind or visually impaired persons including facilitating such tasks as navigation and product selection.

### BACKGROUND OF THE INVENTION

The invention is related to the fields of assistive technology, orientation and mobility (O&M) and informational aids/systems for those with blindness or other forms of vision loss. For many years there have been attempts to provide systems that would inform a blind or visually impaired (B&VI) pedestrian as to their location, direction of travel and the environment surrounding them. Many of these more current systems employ radio frequency (RF) transponders and make a positive example of the inadequacies of many of these attempts.

For example, U.S. Pat. No. 5,144,294 describes an apparatus including a portable RF tag carried by the user and a stationary base RF tag unit. The portable RF transmitter transmits a message request signal in response to manual activation of a transmit button by the user. Finding the transmit button while simultaneously orienting within an environment challenges a B&VI pedestrian, and the use of a large number of transmitters located within any city environment appears unfeasible with expanding complex electronic and telecommunication devices.

Apparatuses based on white canes for B&VI person also incorporate other technologies, such as sonar and laser technology. Both work as obstacle or hazard detectors for the B&VI traveler. However, neither hazard detection component has been incorporated into a white cane with other modem advancements, such as barcode systems, global positioning satellite (GPS) or laser technologies.

Similarly, there are devices available that scan and/or identify products through the use of the Universal Product Code (UPC) barcode system. Presently however, there are no such devices that provide B & VI persons with access to general product information through audio output, and only one device will scan and read via audio output a UPC on specific drug containers (insulin). There are also devices that will identify via audio output the colors of objects or products. However there are currently no such devices that will, through audio output, identify both product UPC codes and colors through a combined scanning audio output system.

Persons who are B&VI have varying levels of difficulty in finding or accurately orienting themselves to any given location. For B&VI travelers, identifying a current location, orienting within a strange or subsequently new environment or locating a potential small objective is problematic. Locating a particular street or building, a street address or block number or any smaller objective during daily mobility are difficult objectives for vision-impaired pedestrians. These O & M tasks however, are of primary importance during any B & VI traveler's daily activities. The ability to negotiate safe orientation within a subsequent environment is the secondary, yet no less important objective of a blind traveler's O & M activities.

A final common objective during O & M is often the location and identification of small objectives. A B & VI pedestrian may have difficulty finding a certain street or address, then have problems locating a bus stop, entrance, doorway or bus route sign, and once these objectives are completed, problems arise in locating or identifying secondary micro-environmental objectives, such as restroom entrances, product storage areas or specific small objectives like individual products or the color of said products or items.

### BRIEF DESCRIPTION OF THE DRAWINGS

FIG. 1 is an isometric view of the location orienting system configured for barcode-reading operation according to an embodiment of the invention.

FIG. 2 is a block diagram of the location orienting system wherein the informational barcode having elongate bars with two different colors are located on various barcode sites such as detectable warnings (e.g.,truncated dome/tiles, etc.) at street corners shown schematically in aerial view according to an embodiment of the invention.

FIG. 3 is a block diagram of the location orienting system wherein the barcode scanner is connected to the microcomputer by wire to the receiver according to an embodiment of the invention.

FIG. 3a is a block diagram of the location orienting system wherein the barcode scanner is connected to the microcomputer by a transmitter and receiver according to an embodiment of the invention.

FIG. 4 is a side elevation view in cross-section of a cane incorporating a barcode scanner that is wired to the receiver according to an embodiment of the invention.

FIG. 4a is a side elevation view in cross-section of a cane incorporating a barcode scanner that is wireless to the receiver according to an embodiment of the invention.

FIG. 4b is a diagram depicting the flow from the barcode scanner to the decoder according to an embodiment of the invention.

FIG. 4c is a sonar obstacle alert that starts at fifteen feet and vibration is in the handle of the cane according to an embodiment of the invention.

FIG. 4d is a diagram of the decoder-reader depicting the flow of information from the cane to the decoder in which the decoder decodes the information and sends the signal on to the earphone according to an embodiment of the invention.

FIG. 5 is a side view of the handheld scanner incorporating a barcode/color scanner that is wireless to the receiver according to an embodiment of the invention.

FIG. 5a is a diagram of the barcode/color scanner depicting the flow of information from the barcode/color scanner to the decoder according to an embodiment of the invention.

FIG. 6 is a generic example of a retail store illustrating where the barcodes are placed on shelves, wherein the handheld barcode/color scanner reads the UPC barcode and sends the signal to the user according to an embodiment of the invention.

FIG. 6a is a view of the barcode/color decoder with earphone according to an embodiment of the invention.

FIG. 6b is [a] an aerial view of a generic floor plan of a grocery store, or retail store, with a barcode placed into the tiles so that the cane reads the barcode, such that the user then knows what is on the aisle, e.g. vegetables, soup, and other items such as clothing or accessories according to an embodiment of the invention.

FIG. 7 is an isometric view of the location orienting system configured for radio frequency identification (RFID) operations according to an embodiment of the invention.

FIG. 8 is a block diagram depicting portions of a RFID decoder according to an embodiment of the invention.

FIG. 9 is a diagrammatic side view depiction of a wheelchair equipped for RFID operation according to an embodiment of the invention.

FIG. 10 is a block flow diagram of a method of providing an location and/or orientation device and/or system according to embodiments of the invention.

FIG. 11 is an isometric view depicting directionally selective reception of carrier waves by a transparent portion of an assist device according to embodiments of the invention.

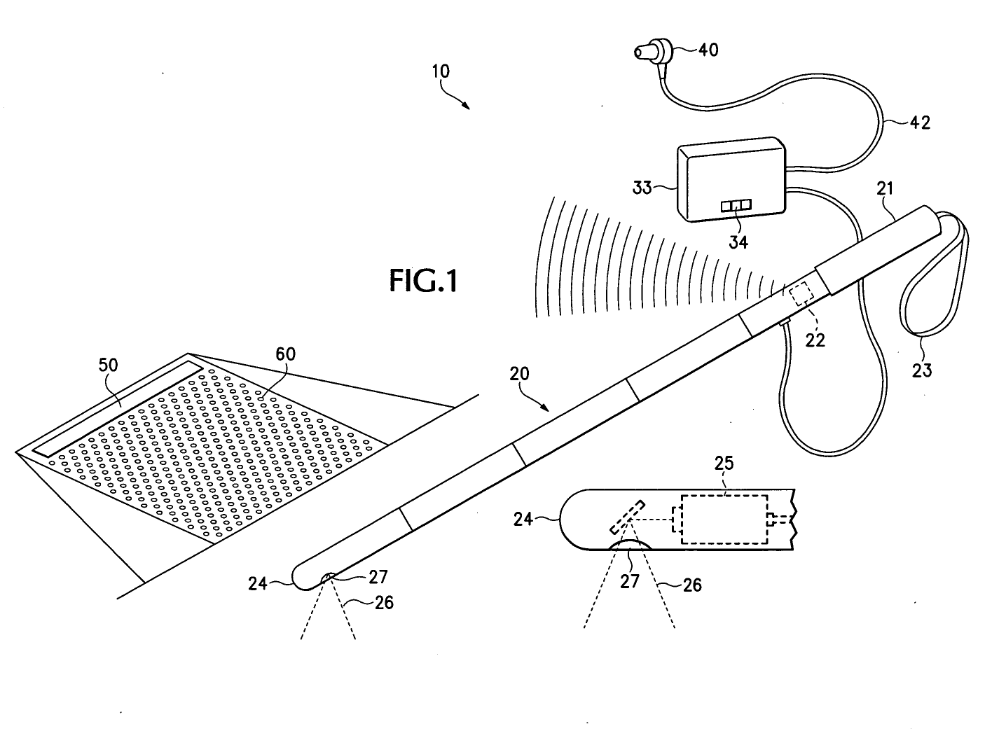

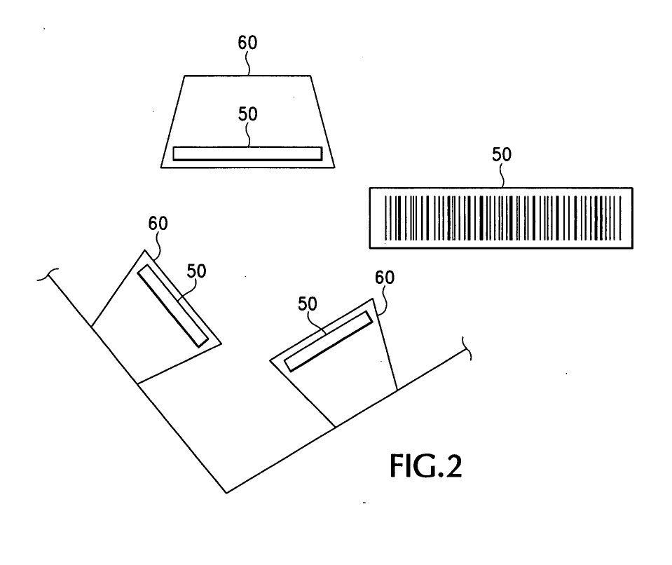

### DETAILED DESCRIPTION OF THE PREFERRED EMBODIMENTS

Broadly speaking, location, orientation, and color identification systems for the blind or visually impaired are described. Those of skill in the art will appreciate that the component parts and functions of the invention according to one or more embodiments are briefly summarized in Table I below.

TABLE I
LOCATION, ORIENTATION, PRODUCT AND COLOR
IDENTIFICATION SYSTEM FOR THE BLIND OR
VISUALLY IMPAIRED
Components List

| | |
|---|---|
| 10 | Location Orienting System |
| 20 | Cane |
| 21 | Handle |
| 22 | Sonar Obstacle Alert |
| 23 | Wrist Loop |
| 24 | Tip |
| 25 | Barcode Scanner/Alert |
| 26 | Beam (e.g., Laser, etc.) |
| 27 | Window (e.g., Laser, etc.) |
| 28 | Mirror |
| 29 | Battery |
| 30 | Cable or Wireless Signal |
| 31 | Microprocessor |
| 32 | Hardwire or Wireless |
| 33 | Barcode/Color Decoder |
| 34 | On, Off and Volume Switch |
| 35 | Speech Synthesizer |
| 40 | Earphone |
| 42 | Hardwire to Earphone |
| 50 | Informational Barcode |
| 60 | Detectable warnings (e.g., truncated |
| | dome/tiles, etc.) |
| 61 | Radio Transmitter |
| 62 | Receiver |
| 70 | Barcode and Color Scanner |
| 71 | Wrist Loop |
| 72 | On and Off Switch |
| 73 | Battery Compartment |
| 74 | Trigger |
| 75 | Transmitter |
| 76 | Reader |
| 77 | Edge Catcher |

A major component or location orienting system of the present invention interacts with a plurality of informational barcode sites located on city sidewalks, intersections, and at or upon other locations. Each informational barcode site contains information about its location in a barcode format. A barcode scanner is located adjacent to and at the lower end (tip) of a white cane carried by a blind or visually impaired user.

The barcode scanner is adapted to read the respective barcode contained at the informational barcode site by passing the tip of the cane containing the barcode scanner over the informational barcode site. The barcode scanner generates an electrical signal that is relayed to a microcomputer component worn by the blind or visually impaired user. The microcomputer decodes the barcode information into a signal that is sent to a speech synthesizer. The speech synthesizer generates an audio signal that is transmitted to an earphone worn on the ear by the blind or visually impaired user.

The signal generated by the barcode scanner can be transmitted to the microcomputer by wiring connecting the two, or by sending the signal to a transmitter located within the cane and wirelessly transmitting the signal to the microcomputer component.

A similar embodiment includes a cane or another assist device (e.g., wheelchair, crutch, walker, etc.) configured to detect, identify, and obtain information from one or more radio frequency identification (RFID) tags located in an environment within, through, or proximate to which a B & VI user can navigate. The assist device includes components configured to scan the environment for nearby RFID tags, and to convey to the user an audio output including information (e.g., spoken language) relevant to the environment. Such information enables a B & VI person using an RFID-equipped assist device to navigate within an environment, including safely accessing some areas, and avoiding obstacles and other dangerous areas.

A complimentary portable, hand-held component can be used either separately or simultaneously with the primary white cane-audio components, to provide audio information to users on either barcode (UPC) product information or the color of a product or item. This hand-held component utilizes standard UPC barcode scanner technology to process barcode site information obtained via the said sites in a plurality of product environment locations. The complimentary portable component also incorporates color scanner technology to process the colors in a plurality of product and daily activity environments. Both incorporated UPC product and color scanners can independently generate electrical signals to be transmitted to the microcomputer. Signal transmission can be completed by either wiring to connect the scanner to the microcomputer, or by sending the signal to a wireless transmitter located within the hand-held component and wirelessly transmitting the signal to the microcomputer.

Thus, the invention allows blind or visually impaired (B & VI) pedestrians safely to negotiate unfamiliar or known environments that have been marked with barcodes, to obtain detailed audio/verbal information that sighted pedestrians generally have access to, and to avoid typical and/or dangerous hazards on their route by sensing the vibrating handle or hearing the drop-off alert. Additionally and upon their safe arrival at various destinations, the B & VI pedestrian can have safe and equal audio/verbal access to information regarding myriad route, distance, destination, transportation, product, etc., all subject to being bar coded.

The location orienting system 10 includes a cane 20, a microcomputer 30, and an earphone 40. Cane 20 comprises a long tube of aluminum, fiberglass, or graphite, and has the appearance of a standard white cane used by the blind or visually impaired. White canes used by the blind or visually impaired come in two basic types: the rigid cane and the folding cane. The rigid cane is made of a long tube of steel, aluminum, fiberglass, carbon fiber or graphite with a handle 21 on one end and a nylon tip on the other. The handle 22 may have a wrist loop. The folding cane is made of similar materials and looks equal to a rigid cane, except that it is broken up into several tubular sections that are held together by an elastic cord running through the middle of the tubing, which allows the sections to be pulled apart and folded away when not in use.

Cane 20 has a handle 21, wrist loop 23, and tip 24. A barcode scanner 25 is located within the tubular body of cane 20 adjacent to the tip end barcode scanner 25 is a conventional type, which includes a laser scanner that generates a laser scanning beam 26, and a detector, which converts the on-off pulses of the rays reflected from a barcode into an electrical binary code signal that is transmitted via a serial cable 30, for example, to the microprocessor or microcomputer 31 via hardwire or wireless signal transmitter 32. The scanning beam 26 from the laser scanner is reflected downwardly through a laser window 27 in the body of the cane 20. The scanning beam 26 is bent at an angle of approximately [90] ninety degrees (90°) to the longitudinal axis of the cane 20 by means of a semi-silvered mirror 28. The semi-silvered mirror 28 allows the beam reflected from the barcode to pass through the mirror and to impinge upon the detector.

Within the spirit and scope of the invention, barcode scanner 25 can assume any suitable form and provide any level of functionality. But those of skill in the art will appreciate that in accordance with one embodiment of the invention, barcode scanner 25 performs in accordance with the performance parameters illustrated in Table II below.

TABLE II
Barcode Scanner Specifications

| | |
|---|---|
| Illumination | Red, λ = 660 nm |
| Wavelength | |
| Resolution | 5 mil (min) |
| Tilt Angle | 35° max |
| Depth of Field | Contact scanner |
| Print Contrast Ratio | 0.35 min |
| Scan Velocity | 2 to 60 inches/second |
| Ambient Light | 100 kilolux sunlight; |
| Rejection | 2 kilolux fluorescent |

A rechargeable battery pack 29 is located in the handle portion of cane 20 and provides power to barcode scanner 25. The microcomputer 31 has a barcode decoder 33 programmed to decode the signal generated by the detector of the barcode scanner 25. The binary numbers of the barcode represent decimal numbers or letters, or their combination, or any other suitable symbol or symbols, which characterize the geographical location of the barcode site. The decoded signal generated by the barcode decoder 33 is transmitted to a speech synthesizer 35, which generates an audible (preferably spoken word/phrase, or “spoken-language”) signal that is transmitted to earphone 40 via hardwire cable 42 [to] thereby to inform the user of his or her location. For example, the message could be: “100 block, East Broadway; intersection with Pearl”.

Those of skill in the art will appreciate that serial cable 30 can assume any suitable form or level of functionality. But in accordance with one embodiment of the invention, a standard serial interface cable is used that meets any suitable standard such as the famous IEEE RS-232 standard.

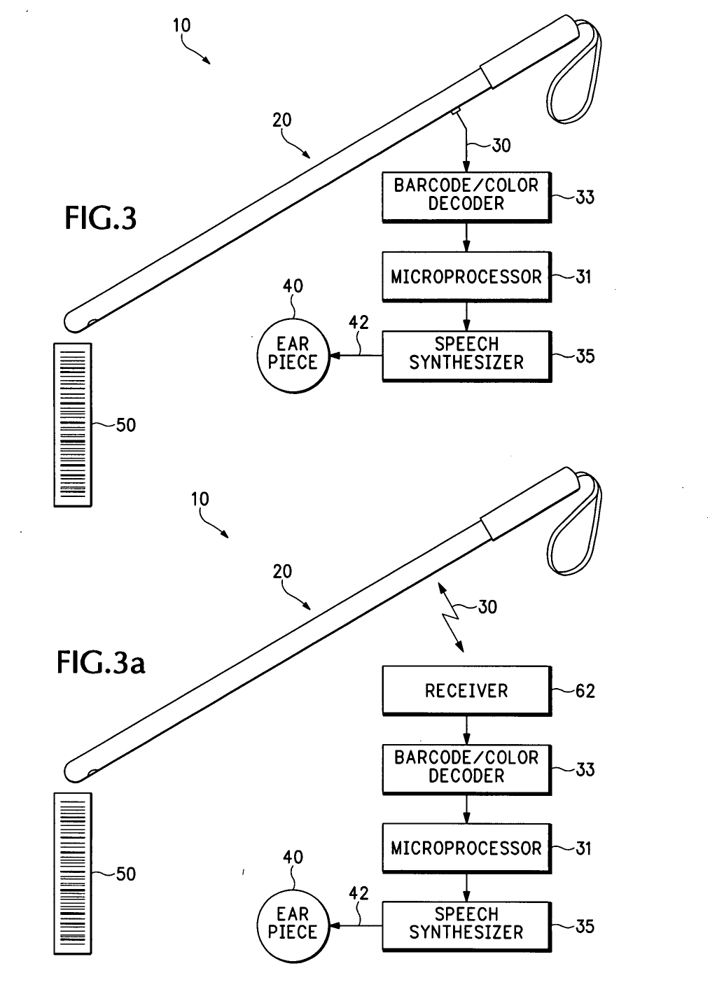

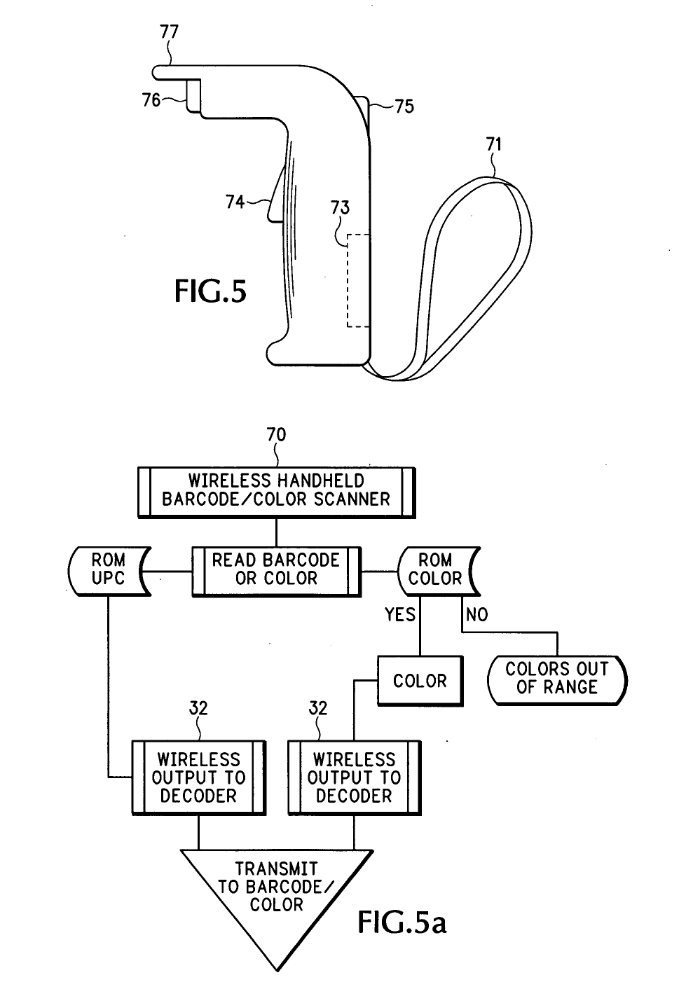

A wireless embodiment of system 10′ and 70 is shown in FIGS. 3a and 5a. In this embodiment, the signal generated by the detector of barcode scanner 25 is transmitted to a radio transmitter 61, which transmits the signal to receiver 62. Receiver 62 transmits the received signal to barcode decoder 33. The remainder of the data processing for system 10 remains the same as in the wired embodiment of system 10.

The barcodes containing geographic or other information may be placed at any suitable street location within the pedestrian right of way that can be easily located by a blind or visually impaired person using a white cane. One such suitable location would be on a sidewalk just before the expansion joint near a crosswalk, at the leading edge of detectable warnings 60 (e.g.,truncated dome/tiles, etc.) now mandated by the Americans with Disabilities Act (ADA).

Other suitable locations for informational barcode sites include the pavement adjacent to bus stops, at the entry areas of transit stations, in malls, in front of individual businesses, within retail establishments, etc.

The informational barcode can be secured to the pavement or other suitable surfaces by the use of a weather- and traffic-proof adhesive, such as the epoxy resin adhesive used to secure highway traffic markers to the pavement on interstate freeways.

### Primary Application Summary

A primary application for the invention is providing a location orienting system for a blind or visually impaired user. The system includes a plurality of barcode sites placed at a plurality of locations within a geographical area, each barcode site containing a barcode that contains information about its geographical location in barcode format. The user carries a white cane having a tubular body containing a barcode scanner adjacent the tip end of the cane. The barcode scanner generates a scanner beam, which passes through a window in the tubular body of the cane to scan the barcode at the barcode site at which the user is positioned, and generates an electrical signal in response to the scan. The electrical signal is transmitted to a microprocessor that is programmed to translate the electrical signal into an audio signal, and to transmit the audio signal to an earphone worn by the user.

Thus the invented Cane Magic™ system will alert the visually impaired user of obstacles in their path and slightly above head height, detect dangerous elevation changes or drop-offs that loom ahead of a user, and allow users to orient themselves and gain further information by hearing an audio message that is produced via an internal barcode scanner in the tip; the barcode scanner will alert the user to drop-offs as well with a constant beep sound.

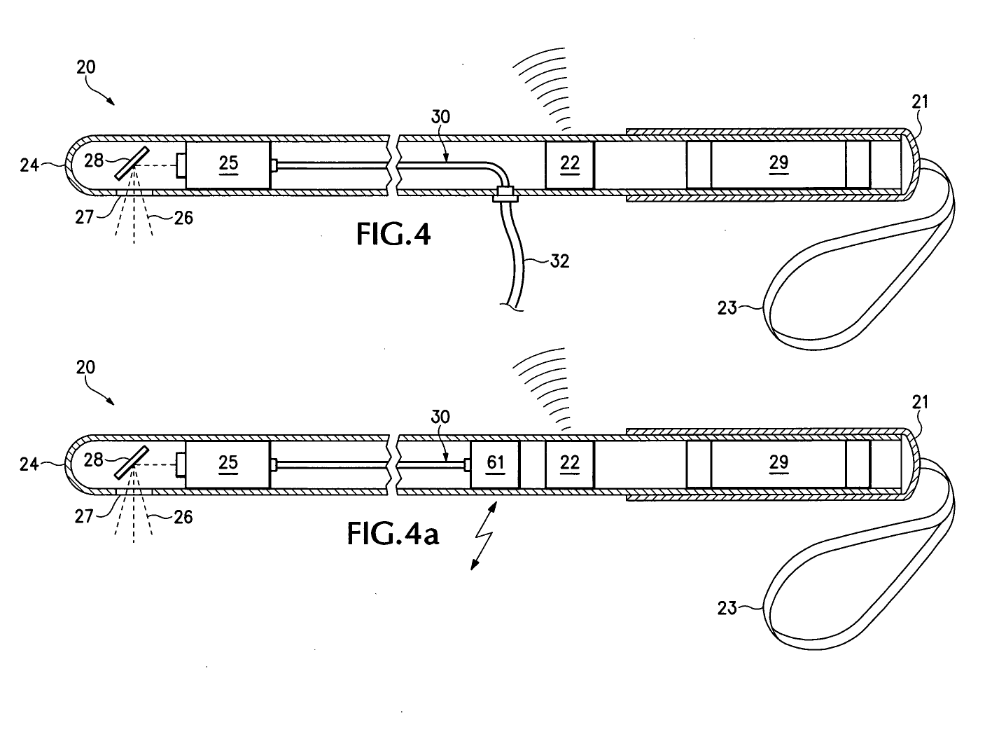

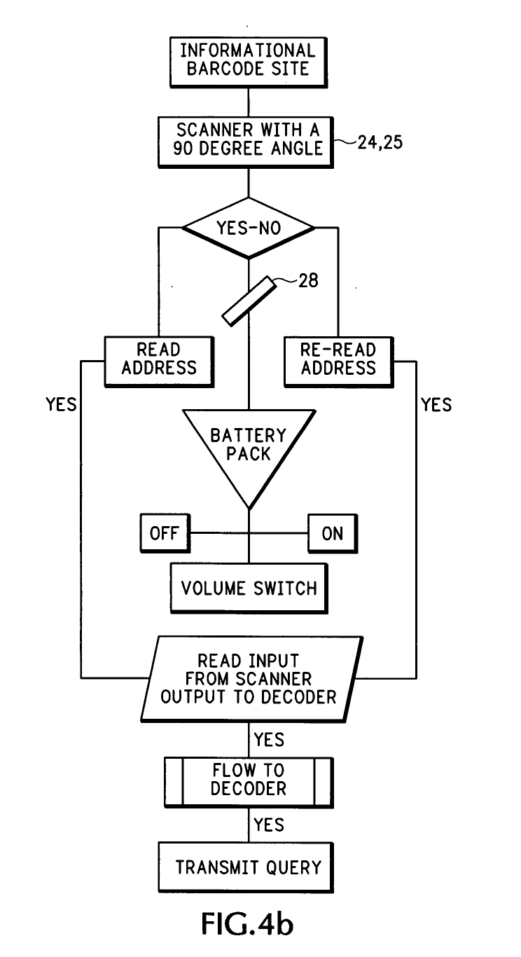

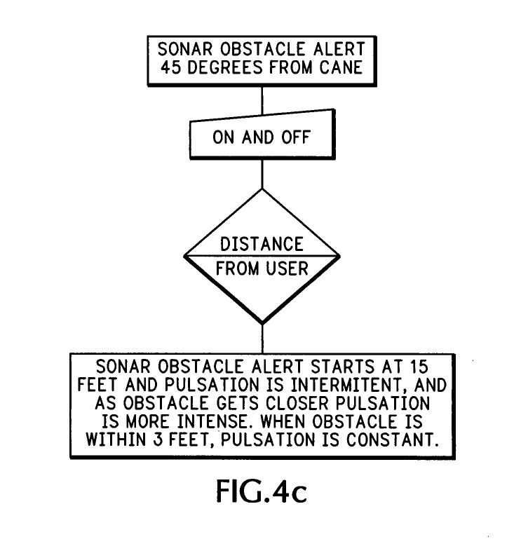

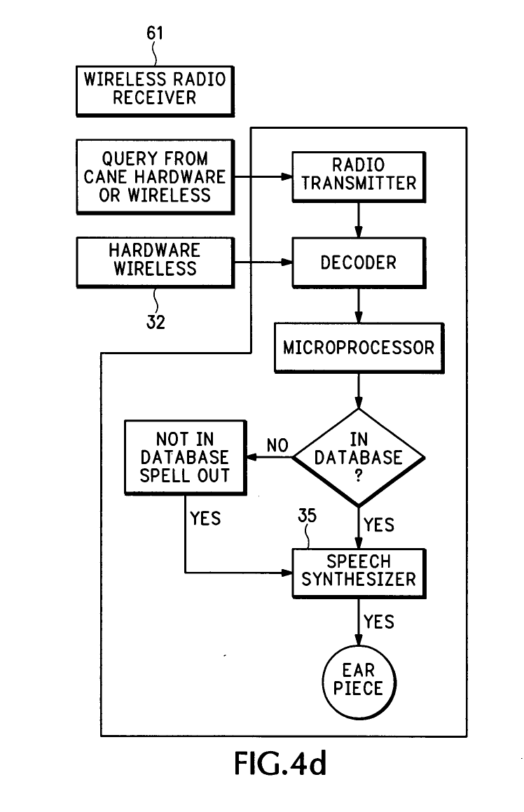

Through current sonar technology incorporated within the invented handle, in accordance with FIG. 4C, the handle will vibrate upon sonar detection of an obstacle, thereby allowing high levels of directional awareness of obstacles for improved safety for the blind or vision impaired user. The sonar unit will detect obstacles in the pathway as far out as fifteen feet and as close as the end of the sonar sending unit placed at the lower end of the cane handle.

A sonar component placed within the Cane Magic™ handle (reference designator 22) will be an ultrasonic dispersal and reception unit that will alert the user to the presence and distance of obstacles in his or her path. The electronic dispersal and reception unit is incorporated in the cane handle, with the electronic emitting region (ridge) being located along the lowest edge of the handle-cane connection. Working in conjunction with the sonar reception (detection) unit and set into the upper portion of the Cane Magic™ handle is a variable strength vibration production unit. The vibration unit reacts to a sonar (radar) bounce) that is received by the reception unit and is subsequently relayed to the vibration unit, hence alerting the user to obstacles in his or her path. The strength of the handle vibration will depend on the strength of the bounced signal (registered proximity of obstacle) allowing users to react in accordance with the forward directional proximity and perceived danger. The unit producing the vibration within the handle emits a varying strength vibration depending on the proximity of the obstacle. A slight intermittent vibration is produced when an object is within 10 to 15 feet (directly) ahead of the handle's sonar unit, a medium intermittent vibration is produced at 5 to 10 feet proximity of an obstacle, and when the object is closer than 5 feet from the reception unit the handle vibration is constant. The handle sonar unit will both produce and receive the electronic pulse and the cane may be produced either with or without the sonar component, according to consumer preferences.

Alternatively or additionally, in accordance with the invention, incorporation in the cane of an elevation detection unit that is a part of standard UPC barcode scanners containing a laser beam sensing unit to contact and read the barcode site. Within the Cane Magic™ design, this sensory unit (reference designator 26) will be modified to provide an audio alert when a set distance from the cane tip (reference designator 24) scanner to the pavement or reflective surface is exceeded. As the barcode scanner beam is set to a given distance and this distance is exceeded, a signal is relayed to the barcode decoder (reference designator 33) and then a decrypted signal is relayed to the audio translation unit (reference designator 33) and subsequently sent to the audio production unit (reference designator 40). The emitted warning alert for elevation changes or drop-offs will be a constant beep and be different from vocal information audibly provided through the component, thereby clearly alerting the user. This warning tone will be the only sound differing from the voice (descriptive information) output produced by the audio translation and production components.

### Secondary Application Summary

A secondary application closely resembles the primary application in many structural, functional and other aspects. In fact, an embodiment of a radio frequency identification (RFID) equipped cane, for example, can be visually almost indistinguishable in external appearance from a barcode-equipped cane as described above. However, an RFID-equipped cane and a barcode-equipped cane will also differ significantly in alternative embodiments. For example, rather than barcode-based navigation and identification, an embodiment of a secondary application enables RFID-based navigation and identification. Therefore, one having ordinary skill will recognize that several barcode-based components in an embodiment of the primary application are replaced with RFID-based components in an embodiment of the secondary application, or are simply removed altogether as unnecessary and/or duplicative. Although numerous embodiments herein describe a cane, the embodiments are not so limited, and numerous other assist devices for B & VI persons are included within the scope of the invention, as will be discussed and described below.

A key difference between the primary and secondary applications involves the environmental information sources detected, identified and/or interpreted by an RFID-equipped cane or other assist device. Rather than optically detectable barcodes located at or near ground level to be read by a scanning beam emitted from a lower end of a cane, RFID tags and/or microchips (collectively, environmental RFID tags) can be located nearly anywhere in an environment within, through, and/or proximate to which a B & VI user may travel. Of course, environmental RFID tags can also be placed anywhere that a barcode can be placed, as described above.

RFID tags typically comprise at least an antenna configured to receive a carrier wave and/or reflect a portion of the carrier wave to a receiver/detector. Alternatively, an RFID tag can also include an integrated circuit encoded with data, which data can be transmitted in response to receiving a carrier wave including a radio frequency signal. Radio-frequencies belong to a portion of the electromagnetic spectrum including electrical signals oscillating at a frequency within a range of approximately 3 Hz-30 GHz, a substantial portion of which may be used according to embodiments of the invention. For example, some exemplary wavelengths and/or frequency ranges of the electromagnetic spectrum that can be utilized include very long wave (e.g., 9-135 kHz), short wave (e.g., 13.56 MHz, etc.), UHF (e.g., 400-1200 MHz), and/or Microwave (2.45, 5.8 GHz, etc.), although the embodiments are not so limited. Radio frequency usage is typically controlled by governmental authorities, so practice of embodiments may be limited to approved frequencies in particular areas and/or times. However the scope of embodiments embraced by the invention are not limited only to those frequencies currently approved for use, as such restrictions may vary and/or be removed from time to time.

RFID tags placed at locations within the environment are then available to be detected, identified and/or interpreted by RFID-based components in an embodiment of the invention. For example, embodiments of the invention described herein provide notable benefits when used with relation to environmental tags placed at or near ground level (e.g., embedded in and/or affixed to surfaces traversed by pedestrians, such as sidewalks, floors, streets, stairs, etc.). This is due to the fact that obstacles at or near ground level present particular hazards to B & VI persons.

Further, RFID-based systems are not dependent upon a ‘line of sight’ relationship with an environmental tag in the same way as an optical barcode reader. Therefore, while environmental tags can be located at ground level in embodiments, they can just as easily and effectively be located above ground level, such as in a sign, a wall, or a stairwell, although the embodiments are not so limited. Environmental tags can be used in buses, airplanes, theaters, stadiums and other public accommodations, to identify seat locations for example. Generally, environmental tags can be used in nearly any public, commercial, and/or private location that a B & VI person would likely benefit from obtaining information about the proximate environment that would otherwise be easily and/or visually accessible to a non-B & VI person.

Each RFID tag located within an environment includes information encoded in RFID format regarding its location within the geographical area, and in an embodiment, can contain other information beneficial to a B & VI person. When an RFID-equipped assist device, such as a cane, wheel chair, or other such device passes within transmission/detection range of an environmental RFID tag, an RFID scanner within the device detects the RFID signal and generates an electrical signal corresponding to the RFID signal. The electrical signal typically includes binary data derived from the RFID signal, wherein such binary data includes information pertaining to a user's surrounding environment. The electrical signal is then transmitted to a microprocessor, which translates the electrical signal into a form from which an audio output device (e.g., transducer, speaker, earphone etc.) can produce an output that is audible to or otherwise detectable and understandable by a user.

In an embodiment, an audio output device comprises a headset and/or earphones worn by a user, enabling a user to hear even a low volume audio response, or to hear an audio response in a relatively noisy area. In other embodiments, the audio output device can include a speaker, a vibratory device configured to convey audio information to a user through the user's bones, or other devices configured to provide auditory information to a user. In general, an audio signal includes any signal provided as input to an audio output device and including a representation of binary data included in the RFID signal received by the RFID scanner from an environmental RFID tag.

The information contained and conveyed by an environmental tag can simply be information providing a location (e.g., “100 block, East Broadway; intersection with Pearl”), or may alternatively or additionally provide information enabling a user to successfully navigate obstacles located within or near the geographic area. For example, an environmental tag at the top of a stairwell may inform a user of the number of stairs in the stairwell, the location of handrails, or other useful navigational and assistive information.

Unlike a barcode, which must generally be directly encountered and scanned within the boundaries of the barcode in order to be properly detected and interpreted, an environmental RFID tag can be detected and/or identified from a operative distance (up to approximately 50 feet). Alternatively, detection and/or identification of an environmental RFID tag according to another embodiment may require close proximity of a RFID scanner. The operative distances for detection and/or identification of an environmental RFID tag depends upon several factors including characteristics of the environmental RFID tag, characteristics of the RFID scanner, environmental electromagnetic interference, interposition of structures between an environmental RFID tag and a RFID scanner, and/or other factors.

In a typical embodiment, a scanner properly detects and identifies an environmental RFID tag only when the scanner closely approaches the tag. For example, an environmental RFID tag at the top of a stairwell, if detectable at a substantial distance (e.g., approximately 2 meters or more) may not provide sufficiently useful information regarding a user's position relative to the stairwell. However, if detectable only when within approximately 2 meters, a user can then know to begin searching for the top (or bottom) stair with their cane for example. An operative distance can vary substantial according to the type of obstacle, object, or other feature marked with an environmental RFID tag.

For this same reason, in a typical (although not exclusive) embodiment of an RFID-equipped cane, the RFID scanner is located relatively closely to the bottom end of the cane, and therefore it is typically held relatively close to ground level during normal use. When so positioned, a scanner can detect signals from even relatively weak environmental RFID tags located at ground level. Likewise, the user will then judge the location of an environmental RFID tag relative to the end of the cane, similar to the way a user generally judges the location of physical objects relative to the end of a standard B & VI assist cane encountering such objects. Therefore, an RFID scanner located proximate to a bottom end of a cane can provide a user with a more intuitive positional assessment of RFID-marked locations in the surrounding environment.

In alternative embodiments, environmental RFID tags can be either passive, semi-passive, or active (collectively referred to hereinafter as RFID tags for simplicity). Passive RFID tags have integrated and/or associated power source. Rather, an incoming radio frequency signal emitted (e.g., as a carrier wave) from an RFID scanner induces a minute electrical current in the antennae of an environmental RFID tag. When the incoming signal is strong enough, due to proximity of the RFID scanner to the RFID tag for example, the electrical current will be sufficient to power-up an integrated circuit in the RFID tag and backscatter the carrier wave as a response signal that can be detected by the RFID scanner.

Alternatively, an antennae of an environmental RFID tag can be configured to induce a current in response to and based upon a specific frequency and or frequency range of a carrier wave, for example. Passive environmental RFID tags typically have an operable maximum range of approximately 10 centimeters up to several meters (also depending upon one or more of a characteristics of an incoming signal, antennae configuration of the environmental RFID tag, power requirements of an integrated circuit of the environmental RFID tag, and/or other factors). In generally, characteristics of a carrier wave, such as frequency, amplitude, etc., will affect the range over which a transmitted signal can induce a response signal from an environmental RFID tag.

Therefore, in an embodiment, a user obtains a measure of control over detection distance between an RFID-equipped assist device and an environmental RFID tag by modulating the amplitude, frequency, or another characteristic of an interrogation signal/carrier wave output by the RFID scanner. A higher output signal power level can provide detection and identification of an environmental RFID tag at a greater distance, while a lower output signal power level conversely limits detection and identification to a shorter separation distance between the RFID scanner and source. For this reason, an embodiment of the invention includes a feature and/or method for modulating power levels, frequency, or other characteristics of an interrogation signal transmittable by an RFID-equipped assist device.

Semi-passive environmental RFID tags include a power source configured to power an integrated circuit but generally not configured to transmit a signal. Therefore, a semi-passive environmental RFID tag can be detected and identified by a similar device and/or method as a passive environmental RFID tag, wherein at least a portion of an incoming interrogation signal from an RFID-equipped assist device is reflected back (e.g., backscattered) by the antennae of a semi-passive environmental RFID tag.

Alternatively, environmental RFID tags can be active, including an integrated and/or associated power source configured to not only power an integrated circuit but also to transmit an RFID signal (e.g. conveyed by a carrier wave). Therefore, an active RFID tag can relatively continuously emit a signal that can be detected by an RFID scanner in an embodiment of the invented RFID assist device (e.g., cane, wheelchair, etc.). Active environmental RFID tags are generally detectable over greater distances than are passive environmental RFID tags, for example up to 500-1500 meters. For this reason, an embodiment of the invented RFID assist device can be configured to primarily scan for incoming (response) signals from active environmental RFID tags, whether or not the RFID assist device transmits carrier waves including an RFID interrogation signal.

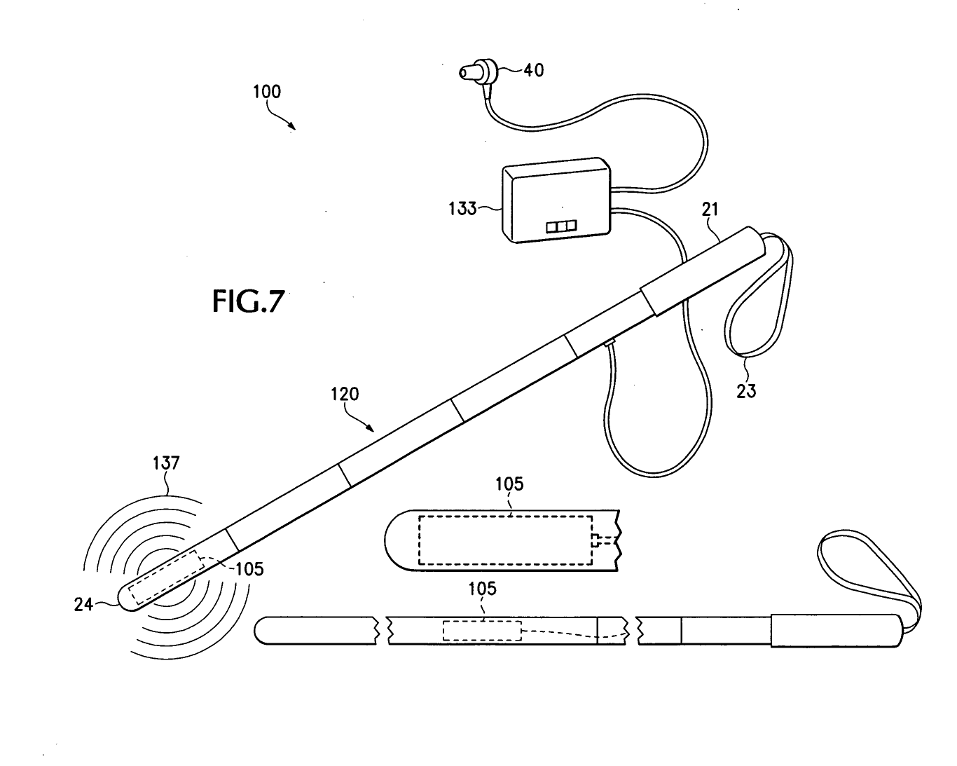

Referring to FIG. 7, numerous features of an RFID-equipped location and orienting system 100 embodied as a cane 120 are similar and/or identical to those of a cane described according to an embodiment of the primary application above, while other features differ substantially. For example, an embodiment of a RFID-equipped cane 120 typically includes a tip 24 and a handle 21 located at or near opposing ends of the cane from one another, and may include a wrist strap 23. An RFID scanner 105 is typically located at least partially within a structural housing of an assist device (e.g., cane, wheel chair, walker, crutch, etc.). In alternative embodiments, an RFID scanner is contained entirely within or otherwise operatively coupled with an assist device. An RFID scanner 105 is typically but not exclusively configured to emit a carrier wave 137 including a RFID interrogation signal. The emitted RFID signal interrogates the surrounding environment for the presence of environmental RFID tags.

An RFID scanner 105 can be configured relatively continuously to emit a carrier wave 137 including an RFID signal, or to emit such RFID signal-bearing carrier wave at a predetermined, user-adjustable interval. For example, a scanner 105 can be configured to begin emitting an RFID signal when a folding or otherwise extensible cane is deployed at full length for use, and continue emitting until the cane is once again folded and/or collapsed. Therefore, one of ordinary skill in the art will recognize that embodiments of the invention do not require a user to press a button or otherwise manually activate a control each time the user wishes to interrogate the user's environment for RFID tags.

Alternatively and/or additionally, the RFID scanner is configured to receive carrier waves including RFID signals (e.g., RFID response signal) emitted by or reflected from active and passive/semi-passive environmental RFID tags, respectively. Within the spirit and scope of the invention, an RFID scanner 105 can assume any suitable form and provide any level of functionality.

An RFID decoder 133 is operatively coupled with the RFID scanner 105 either by a wire or wirelessly in alternate embodiments, and the RFID scanner 105 conveys to the RFID decoder 133 an electrical signal including data included obtained from a carrier wave (e.g., response signal) received at the RFID scanner 105. When wirelessly coupled, each of the RFID scanner 105 and the RFID decoder 133 will include a complementary one of a wireless signal transmitting means (e.g., transmitter, tag, etc.) or a wireless signal receiving means (e.g., antennae, etc.) to exchange a wireless signal with the other of the RFID scanner 105 and the RFID decoder 133.

The RFID decoder 133 interprets the RFID-formatted data and derives information pertinent to the user's surrounding environment therefrom. For example, RFID data transmitted by an environmental RFID tag can include information indicating the presence of a stairwell and indicating that the stairwell includes 20 downward steps. For simplicity, such information can also be provided in a coded, abbreviated, or otherwise specially designated format recognizable to users. For example, a standard format for navigational information may be promulgated under the authority of the Americans with Disabilities Act (ADA), a municipality, or some other authority, and a RFID decoder 133 according to an embodiment of the invention will be able to receive and interpret the RFID information from a received carrier wave.

As described above, locating a RFID scanner 105 at or near the tip 24 of an RFID-equipped cane 120 provides benefits in an embodiment. For example, an RFID scanner 105 can be located within a cane 120 approximately 3 inches above the tip (bottom) end of the cane 120. However, as shown in FIG. 7, an RFID scanner 105 can alternatively be placed nearly anywhere along the length of a cane 120, whether located within the body of a cane 120 or otherwise coupled with or at an external surface of a cane 120. For example, locating the RFID scanner 105 other than at the tip of a cane may provide improved balance and usability of the cane. Further, embodiments of a cane 120 can include foldable and/or telescopically or otherwise collapsible canes. In such embodiments, a RFID scanner 105 is located so that it will not interfere with the folding and/or collapsing action of the cane 120.

When the RFID scanner 105 is located within the body of a cane 120, at least a portion of the cane 120, typically proximate the RFID scanner 105, is comprised of a material that is transparent (permeable) to a carrier wave including an RFID signal within a range of radio frequencies detectable by the RFID scanner 105 (e.g., operable frequencies). For example, one or more radio frequency (RF) transparent windows may be provided in a cane enabling passage of carrier waves at an operable radio frequency between an interior and exterior of a structural housing comprising a portion of a cane, wheel chair, etc.

Further, by controlled use and/or placement of RF-transparent windows and/or other materials in a cane or other assist device, directionality of an emitted carrier wave can be controlled. For example, a uni-directional carrier wave emission can be achieved by providing an RF-transparent material at only one side of an otherwise RF-opaque structural housing (e.g., encompassing only 45 degrees, for example, of the 360 degree circumference of a cylindrical cane) when the RFID scanner is contained within the structural housing. Similarly, bi-directionality, n-directionality, or omni-directionality of carrier wave emission can be provided in alternative embodiments. Therefore, a user controls the direction(s) in which an RFID-equipped assist device (e.g., cane, wheelchair, etc.) interrogates the environment.

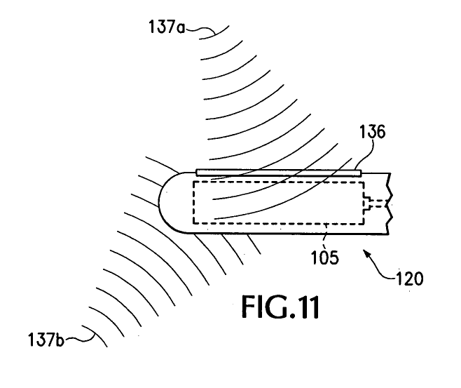

Controlling the location of RF-transparent materials relative to RF-opaque materials in an assist device also enables a user to control the directionality of received RFID signals from environmental RFID tags, solving a critical problem of electromagnetic signal clutter inherent in today's urban, suburban and other environments. As shown in FIG. 11, by limiting the RFID signal bearing carrier waves 137a receivable by an RFID-equipped assist device to only those arriving from within a controllable range, for example by the presence of an RF-transparent window 136 at one portion of the cane 120, a user is able to filter and/or block reception of other RF signals 137b present in the environment. One having ordinary skill in the art will recognize that multi-directionality of RF reception is also possible in a manner similar to that described above regarding multi-directionality of carrier wave emission.

Alternatively, while a portion of the RFID scanner 105 resides within the structural housing of a cane 120, for example, a portion of the RFID scanner configured to transmit and/or receive a carrier wave including an RFID signal can also be exposed to the exterior of the cane 120 and/or reside partially or wholly at the exterior of the cane 120.

As described above and shown in FIGS. 4 and 4a regarding an embodiment of a cane configured to read a barcode, a rechargeable and/or replaceable power source such as a battery (or plurality of individual batteries) is typically but not exclusively located within the handle portion of cane 120. The battery can be integrated with the RFID scanner, or can alternatively be relatively separate from the RFID scanner 105 while remaining operatively coupled thereto to provide power to the scanner 105. The battery can be used to provide power to one or more of the RFID scanner 105, the RFID decoder 133, and/or other components associated with the assist device.

As described, an RFID decoder 133 is operatively coupled with the RFID scanner 105 by at least one of a wireless or wired connection configured to convey a data-bearing electrical signal (e.g., wired or wireless) from the RFID scanner 105 to the RFID decoder 133. The RFID decoder 133 can be securely coupled to a portion of the cane, but more typically is worn by the user. For example, the RFID decoder 133 in an embodiment comprises a compact, wearable unit including an exterior housing and a clip for coupling the decoder 133 securely but removably to a user's belt, pocket, or another portion of the user's clothing. A RFID decoder 133 can likewise be carried in a user's pocket. Generally, the RFID decoder 133 is configured such that a user need not carry it in their hand during normal use, although it may be so carried if desired by a user.

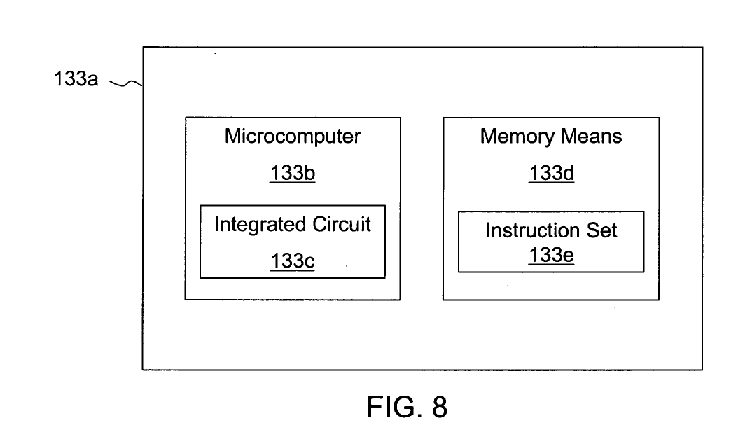

As shown in FIG. 8, the RFID decoder 133 includes within an external housing 133a a microcomputer 133c configured to decode and/or interpret data included within an RFID signal received at the RFID scanner 105. A microcomputer 133b typically includes an integrated circuit device 133c, such as a printed circuit board and/or one or more solid state data processing devices (e.g., silicon chip, etc.). Additionally, an RFID decoder 133 typically includes a memory means 133d (e.g., one or more of a hard disk drive and media, a solid-state memory chip, an optical memory drive and/or media, etc.) at which is stored an instruction set 133e. The instruction set 133e is configured when executed by the microcomputer 133cto cause the microcomputer 133b to convert an incoming signal from an RFID-format into a format capable of causing an portion of an audio output device (e.g., earphone 40, etc.) to vibrate and produce audible output.

The converted/decoded signal generated by the RFID decoder 133 is then, in an embodiment, transmitted to a speech synthesizer, which generates an audio (preferably spoken word/phrase, or “spoken-language”) signal that is transmitted to an audio output device via either a wired or wireless connection. When wirelessly coupled, each of the RFID decoder 133 and the audio output device 40 will include a complementary one of a wireless signal transmitting means (e.g., transmitter, tag, etc.) or a wireless signal receiving means (e.g., antennae, etc.) to exchange a wireless signal with the other of the RFID decoder 133 and the audio output device 40.

Although the various described components comprise a location/orientation apparatus and system for use by B & VI persons, one having ordinary skill in the art will recognize that numerous variations are possible and intended within the scope of the invention. That is, one or more parts of the described device and/or system can be replaced and/or substituted with other relatively similar parts. Unlike barcodes for example, RFID frequency usage is not standardized in most or all countries worldwide, or may be standardized in a manner different from that in the United States. Therefore, a user planning to travel overseas can replace a RFID scanner (or a component thereof) configured to send and/or receive RFID frequencies used in the user's country of residence with one configured to send and/or receive RFID frequencies used in a destination country. Likewise, a user can obtain and store at a memory means alternative instruction sets configured to convert/decode RFID signals and provide audio information in one or more alternative languages.

Conversely, as mentioned above, rather than substituting a component of the RFID apparatus or system with another similar component, an alternate embodiment substantially retains the described components, but houses them within and/or otherwise operatively couples them with an alternative assist device, such as a wheelchair, a walker, a crutch, or another assist device as known in the art. Generally speaking, an assist device within the scope and embodiments of the invention is configured to be at least partially hand operated by a B & VI user.

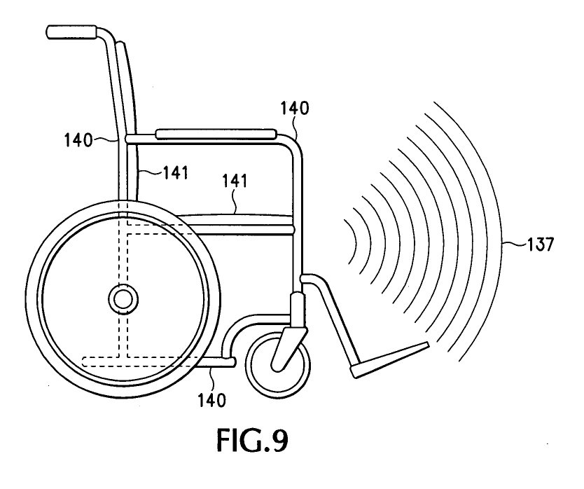

Therefore, a location and/or orientation system according to an embodiment of the invention can include providing an alternative assist device configured to emit a carrier wave 137 including an RFID signal. With reference to FIG. 9, one of ordinary skill in the art will recognize that a wheel chair, for example, typically comprises various structural elements such as tubing 140, padding 141, etc., within or coupled with which operative elements (e.g., RFID scanner, RFID decoder, battery, etc.) of the invention can be provided in an embodiment. The particular arrangement of such components so provided can be varied greatly in alternative embodiments, as will be recognized by one having skill in the art.

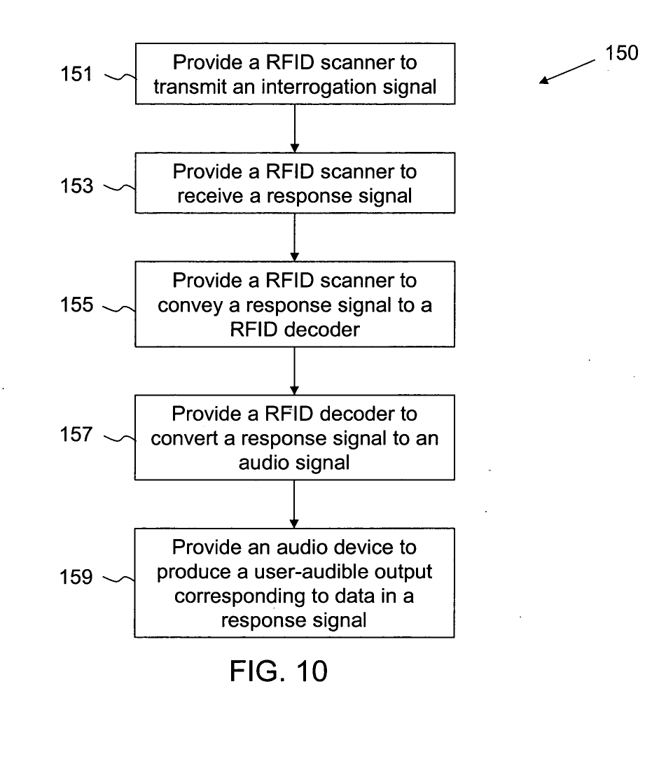

With reference to the embodiment depicted in FIG. 10, the scope of the invention includes a method 150 of providing an RFID-equipped assist device configured as a location and/or orientation system. For example, the method can include providing in a RFID scanner configured to transmit a RFID interrogation signal as at 151 and/or receive a RFID response signal as at 152. As in the depicted embodiment, the method can further include providing a scanner configured to convey at least a portion of the data in a received response signal to an RFID decoder as an electrical signal, as at 153. An RFID decoder so provided can be configured to convert (and/or decode, interpret, etc.) an electrical signal to an audio signal as at 154. An audio device provided as at 155 is configured to produce a user-audible output (e.g., spoken words, a tonal signal, etc.) corresponding at least in part to data present in a received RFID response signal. One having ordinary skill in the art, however, will recognize that the operations and method depicted in FIG. 10 are not exclusive. Rather, without departing form the spirit and scope of the invention, alternate embodiments of a method will include one or more additional operations, omit one or more of the listed operations, or include the depicted operations in alternative forms.

In an embodiment providing substantial benefits to a user, an RFID-equipped assist device will detect an environmental RFID tag separated from the device by a distance within a range of 0-18 inches. This close range provides to the user key information pertinent to the user's immediately surrounding area. However, in alternative embodiments, detection at a greater range can also provide benefits. For example, ground level and other surfaces in a construction zone may continuously change, presenting dangers to a user. Dangerous and large equipment may move into and out of, as well as throughout a construction zone, making placement of a warning perimeter of individual RFID tags logistically impracticable. Rather, a single RFID tag can be affixed to a portion of each piece of dangerous equipment, and/or can be placed at an approximate center of the zone of danger around a construction site, therefore warning a B & VI person of an imminent danger from mobile dangers and/or frequently changing conditions.

Likewise, some dangers to B & VI persons are mobile, including vehicles with which B & VI persons must regularly come into contact. Such mobile dangers include buses, trains, taxi cabs, and other forms of commuter and/or other vehicles. Therefore, an environmental RFID tag can be affixed to a portion of a vehicle to alert a B & VI person of their proximity to the vehicle. Conversely, an RFID tag can be placed within an assist device (e.g., a cane, wheelchair, walker, crutch, etc.), and an RFID scanner and decoder can be located at least partially within or otherwise operatively coupled with a vehicle (e.g., a bus, taxi cab, train, etc.). Therefore, an operator of a vehicle can be warned by a visual indicator or an audible signal from an audio output device when the vehicle approaches within detectable range of a B & VI person using the assist device including the RFID tag. Such warning enables a heightened level of alertness by the operator to watch out for and prevent an accidental collision with a B & VI person.

Additionally, an RFID location system included in a vehicle could further incorporate a memory means configured to store detection event-relevant data (e.g., time, location, B & VI user identification, etc.). Therefore, in the event of an accident involving a B & VI person and a vehicle so equipped, accident investigators will be able to determine a sequence of events. Relevant collected information can include when the system first detected the RFID tag and warned the operator, when the operator began to slow the vehicle via braking, the actual identification of the RFID tag(s) detected at and prior to the time of the accident, as well as any other relevant information.

In other embodiments, an RFID-equipped assist device can also include a sonar component substantially as described above in the Primary Application Summary.

### Tertiary Application Summary

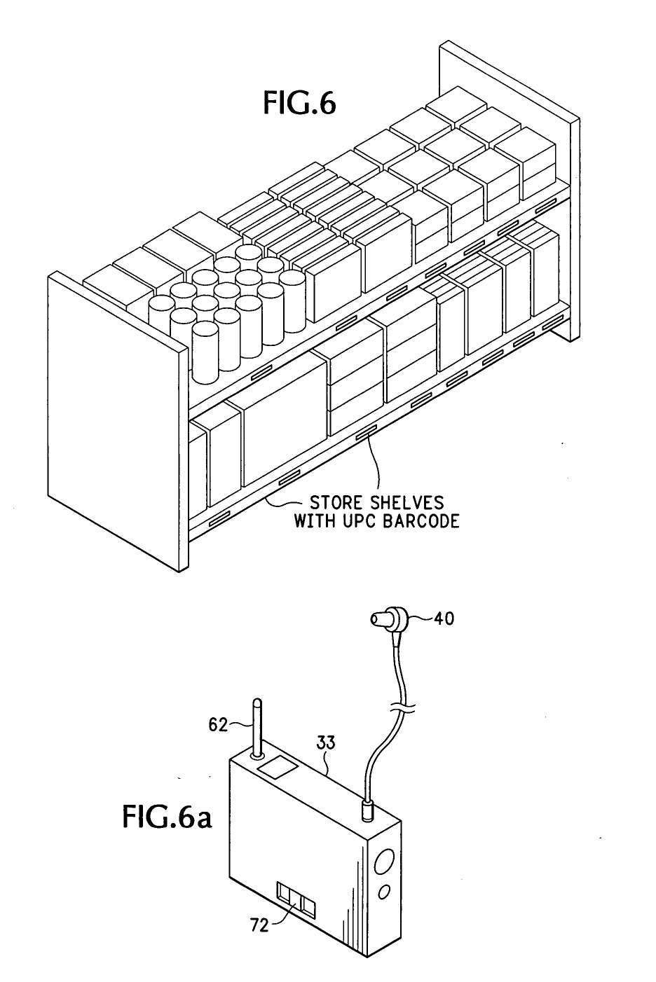

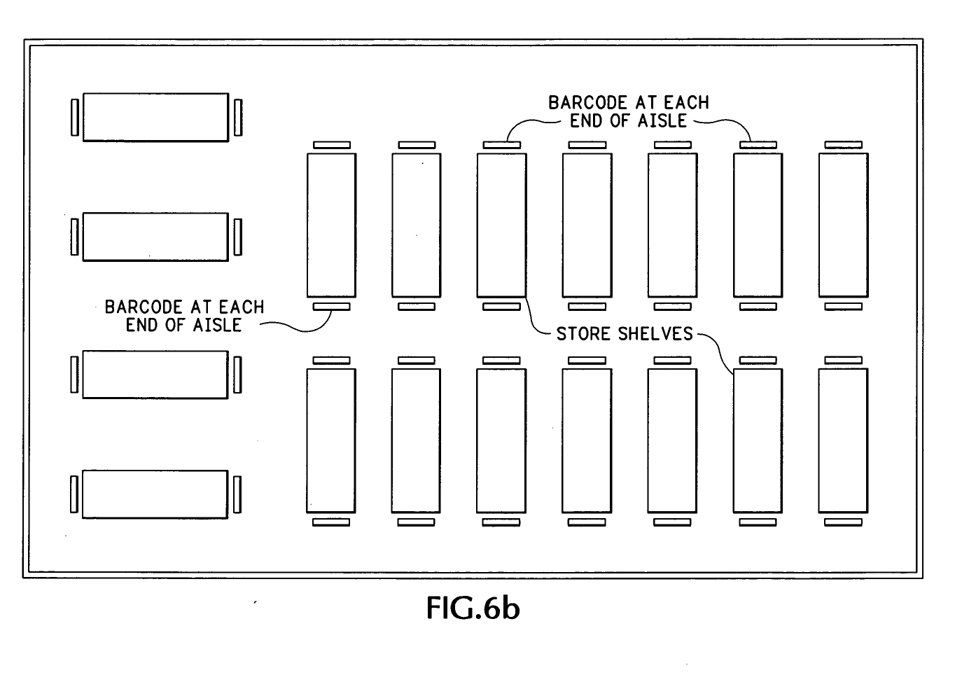

A tertiary application of the invented system is illustrated in FIGS. 5, 5a, 6, 6a and 6b. The system in this embodiment and application provides a hand-held component 70 that is battery 73 operated of a product or color identifying system for a B & VI person. This application of the system includes utilization of two independent scanners (ROM UPC and ROM color) incorporated within the component body to access product barcode or color information. Product information scanned via a plurality of barcode sites can be placed at a plurality of locations within a specific geographic area (e.g. on the floor of a grocery or retail store shown in aerial view in FIG. 6b containing a plurality of products). For example, a plurality of barcode sites including a barcode that contains information about the product in barcode format are strategically located, e.g. at the end of a retail establishment's aisle.

The user carries a hand-held component having a separate barcode scanner incorporated at one end of the component. The barcode scanner generates a scanner beam at a reader 76 adjacent an edge catcher 77, when a trigger 74 is depressed, which scanner beam passes through a window of the component body to scan the barcode at the barcode site at which the user is positioned, and generates a decoder 32 (FIG. 5a) signal in response to the scan. The signal is transmitted via a transmitter 75 to a microprocessor that is programmed to translate the signal into an audio signal, and to transmit the audio signal to an earphone worn by the blind or visually impaired user.

Similarly, and potentially simultaneously, the incorporated color scanner at one end of the component body scans and generates a scanner beam, which passes through a window of the component body to scan an item's color at which the user is positioned, and generates another decoder 32 (FIG. 5a) signal in response to the scan. This signal also is transmitted via the transmitter 75 to a microprocessor that is programmed to translate the signal into an audio signal, and to transmit the audio signal to an earphone worn by the user. Individual component scanners are activated by separate on-off switches and act as independent scanners providing respective product, size, color and/or other information to assist the visually impaired user in retail store navigation and product selection.

The applications specifically described herein do not represent an exhaustive list of all applications or embodiments rendered possible by the invention. Moreover, one or more of the applications described herein are compatible with one another, in that a hand-held cane with its internal electronics can replace the hand-held barcode/color scanner if desired so that only one hand-held device is useful in navigating both streets and stores.

In light of the described embodiments provided above, a person having ordinary skill in the art will recognize numerous advantages provided by embodiments of an assistive device configured as described herein.

A B & VI person using an assistive device configured with barcode, RFID, and/or color scanning capabilities is able to obtain information about the presence and/or characteristics of features and/or objects within the user's environment. Therefore, a B & VI user is able to successfully, more easily, and more safely navigate urban, suburban, and other environment equipped with barcode sites and/or RFID tags. Further, a user is able to acquire information relevant to products located at store shelves, exhibits at a museum, etc., while also navigating successfully within the store, museum, or other interior environment.

A B & VI person is able to obtain encoded information in an audible form from an audio output device, obviating the need to locate and read information from randomly placed tactile signs (e.g. written in Braille, etc.). Therefore, a user can more smoothly navigate through an environment without the need to stop frequently and manually obtain information from frequently difficult to locate Braille placards.

A B & VI person is able to alternatively receive or ignore signals arriving from multiple directions and rather receive only signals arriving from direction selected by the user and/or selected by the configuration of an assist device. Likewise, a user can interrogate an environment for RFID tags in all directions or only one or more specific directions selected by the user and/or selected by the configuration of an assist device. Therefore, environments filled with omni-directional RFID signal clutter do not present a substantial problem for a B & VI person navigating within, through, or proximate to such environment.

An RFID apparatus, system, and/or method described herein can be used with a multitude of different assist devices in alternate embodiments, therefore accommodating user-specific preferences and/or other mobility challenges. Further, combining two or more of the described or equivalent applications (e.g., barcode, RFID, color scanning, etc.) enables a user to have one assist device configured to achieve multiple purposes. In addition to the benefits described herein, one of ordinary skill in the art and/or a user employing any of the described embodiments or any other embodiment within the scope of the invention will appreciate numerous other benefits too numerous to specifically and/or practically list herein.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A radio frequency identification (RFID)-enabled assistive device for a blind or vision-impaired person comprising:
a structural housing configured to enable a blind or vision-impaired person to navigate within a physical environment;
an RFID scanner coupled at least partially within the housing and configured for at least one of emitting a first carrier wave comprising an RFID interrogation signal and receiving a second carrier wave comprising a RFID response signal;
an RFID decoder operatively coupled with the RFID scanner and configured to receive an electrical signal from the RFID scanner wherein the electrical signal includes data derived from the RFID response signal, and further configured to convert at least a portion of the electrical signal to an audio signal; and
an audio output device operatively coupled with the RFID decoder and configured to receive the audio signal from the RFID decoder and to produce a user-audible output including an audible representation of data included in the RFID response signal.

2. The device of claim 1, wherein the RFID scanner is configured to receive a carrier wave from at least one of a passive RFID tag located within the physical environment at a range of approximately 0-5 meters or an active RFID tag located within the physical environment at a range of approximately 0-1500 meters.

3. The device of claim 2, wherein the RFID scanner is configured to receive a carrier wave at a range of 0-18 inches from at least one of an active or passive RFID tag.

4. The device of claim 1, wherein the structural housing comprises an assistive device selected from the group consisting of a cane, a wheelchair, a walker, and a crutch.

5. The device of claim 1, wherein at least a portion of the material comprising the structural housing is transparent to a carrier wave at an operable radio frequency wavelength.

6. The device of claim 5, wherein the operable radio frequency is found within a frequency range selected from the group consisting of very long wave, short wave, ultra high frequency, and microwave.

7. The device of claim 1, wherein the operative coupling between the RFID scanner and the RFID decoder comprises a wireless transmitting means of one of the RFID scanner and the RFID decoder and a wireless receiving means of the other of the RFID scanner and the RFID decoder.

8. The device of claim 1, further comprising;
a control means operatively coupled with the RFID scanner and configured to affect at least one of the frequency and the amplitude of an carrier wave emitted from the scanner to interrogate a surrounding environment for the presence of an RFID tag.

9. The device of claim 1, wherein the audible representation comprises spoken language.

10. The device of claim 1, wherein the RFID decoder includes a stored instruction set configured when executed on a microcomputer to convert binary data in the second RFID signal into an audio signal and to cause a portion of the audio output device to vibrate.

11. A radio frequency identification-based location and orientation system for blind or visually impaired persons, comprising:
one or more radio frequency identification (RFID) tags located within a physical environment accessible to a blind or visually impaired person;
a structural housing configured to be at least partially hand-operated by the person and configured to assist the person to navigate within the physical environment;
an RFID scanner coupled at least partially within the housing and configured for at least one of emitting a first carrier wave comprising an RFID interrogation signal and receiving a second carrier wave comprising a RFID response signal;
an RFID decoder operatively coupled with the RFID scanner and configured to receive an electrical signal from the RFID scanner wherein the electrical signal includes data derived from the RFID response signal, and further configured to convert at least a portion of the electrical signal to an audio signal; and
an audio output device operatively coupled with the RFID decoder and configured to receive the audio signal from the RFID decoder and to produce a user-audible output including an audible representation of data included in the RFID response signal.

12. The device of claim 11, wherein the one or more RFID tags include at least one of a passive RFID tag or an active RFID tag.

13. The device of claim 12, wherein the passive RFID tag is configured to transmit the second carrier wave over a range of approximately 0-5 meters, and the active RFID tag is configured to transmit the second carrier wave over a range of approximately 0-1500 meters.

14. The device of claim 11, wherein the RFID scanner is configured to receive the second carrier wave at a range of 0-18 inches from the one or more RFID tags.

15. The device of claim 11, wherein the structural housing comprises an assistive device selected from the group consisting of a cane, a wheelchair, a walker, and a crutch.

16. The device of claim 11, wherein at least a portion of the material comprising the structural housing is transparent to a carrier wave at an operable radio frequency.

17. The device of claim 11, wherein the operative coupling between the RFID scanner and the RFID decoder comprises a wireless transmitting means of one of the RFID scanner and the RFID decoder and a wireless receiving means of the other of the RFID scanner and the RFID decoder.

18. The device of claim 11, further comprising:
a control means operatively coupled with the RFID scanner and configured to affect at least one of the frequency and the amplitude of the first carrier wave.

19. The device of claim 11, wherein the audible representation comprises spoken language.

20. The device of claim 11, wherein the RFID decoder includes a stored instruction set configured when executed on a microcomputer to convert binary data in the second RFID signal into an audio signal and to cause a portion of the audio output device to vibrate.

21. A radio frequency identification-based system for locating blind or visually impaired persons, comprising:
one or more radio frequency identification (RFID) tags operatively coupled with an assist device possessed by a blind or visually impaired person;
a vehicle configured to be operated by an operator;
an RFID scanner operatively coupled with the vehicle and configured for at least one of emitting a first carrier wave comprising a RFID interrogation signal and receiving a second carrier wave from the RFID tag, the second carrier wave comprising a RFID response signal;
an RFID decoder operatively coupled with the RFID scanner and configured to receive an electrical signal from the RFID scanner wherein the electrical signal includes data derived from the RFID response signal, and further configured to convert at least a portion of the electrical signal to an audio signal; and
an audio output device operatively coupled with the RFID decoder and configured to receive the audio signal from the RFID decoder and to produce an operator-audible output indicating detection of the RFID response signal.

22. A method of enabling a blind or visually impaired person to obtain information relevant to a physical environment within, through, or proximate to which the person can navigate, comprising:
providing a structural housing configured to enable a blind or vision-impaired person to navigate within a physical environment;
providing an RFID scanner coupled at least partially within the housing and configured for at least one of emitting a first carrier wave comprising a RFID interrogation signal and receiving a second carrier wave comprising a RFID response signal;
providing an RFID decoder operatively coupled with the RFID scanner and configured to receive an electrical signal from the RFID scanner wherein the electrical signal includes data derived from the RFID response signal, and further configured to convert at least a portion of the electrical signal to an audio signal; and
providing an audio output device operatively coupled with the RFID decoder and configured to receive the audio signal from the RFID decoder and to produce a user-audible output including an audible representation of data included in the RFID response signal.

23. A product information delivery apparatus for blind or visually impaired persons, comprising:
a hand-portable housing including a window wherein the window is transparent at one or more operative wavelengths;
a barcode scanner located at least partially within the housing and configured to directionally emit a barcode scanning beam through the window, the barcode scanning beam including energy at an operative wavelength;
a color scanner located at least partially within the housing and configured to directionally emit a color scanning beam through the window, the color scanning beam including energy at an operative wavelength;
a power source operatively coupled with one or both of the barcode scanner and the color scanner; and
an audio output device operatively coupled with one or both of the barcode scanner and the color scanner and configured to produce a user-audible output including information relevant to a scanned item.

24. The apparatus of claim 23, wherein each of the barcode scanner and color scanner is further configured to receive a reflected portion of the respective barcode scanning beam and color scanning beam and to generate a respective barcode and color decoder signal including data corresponding to characteristics of the reflected portion.

25. The apparatus of claim 24, further comprising: a microprocessor operatively coupled with and configured to receive at least one of the respective barcode and color decoder signals, and further configured to convert the received at least one decoder signal into an audio signal.

26. The apparatus of claim 24, further comprising:
a transmitter operatively coupled with each of the barcode scanner and the color scanner, and configured to transmit the respective barcode and color decoder signals to the microprocessor.

27. The apparatus of claim 25, wherein the audio output device comprises an earphone configured to receive the audio signal from the microprocessor and to convert the audio signal into the user-audible output.

28. The apparatus of claim 23, further comprising:
an edge-catcher operatively coupled with the housing adjacent to the window and configured to physically engage a portion of a shelf, and further configured to position the window relative to the shelf to enable scanning of items located at the shelf.

29. The apparatus of claim 23, wherein the product-relevant information includes one or both of a color of the scanned item and information encoded in barcode format at a scanned barcode label.

30. The apparatus of claim 23, wherein the power source comprises at least one selected from the group consisting of a rechargeable battery and a replaceable battery.

31. The apparatus of claim 23, further comprising:
at least a first and a second actuation switches, wherein the at least a first actuation switch is configured when actuated to cause the barcode scanner to emit the barcode scanner beam and the at least a second actuation switch is configured when actuated to cause the color scanner to emit the color scanner beam.

32. The apparatus of claim 23, wherein the hand-portable housing comprises a cane.

33. A product information delivery system for blind or visually impaired persons, comprising:
one or more barcode labels located at a store shelf, the one or more barcode labels including information encoded in barcode format; and
a hand-portable device comprising:
a housing;
a window coupled with the housing and configured to divide an interior portion of the housing from an exterior portion of the housing, and wherein the window is transparent at one or more operative wavelengths;
a barcode scanner located at least partially within the housing and configured to directionally emit a barcode scanning beam through the window, the barcode scanning beam including energy at an operative wavelength;
an actuation switch operatively coupled with the barcode scanner and configured when actuated to cause the barcode reader to scan the one or more barcode labels with the emitted barcode scanning beam;
a color scanner located at least partially within the housing and configured to directionally emit a color scanning beam through the window, the color scanning beam including energy at an operative wavelength;
an actuation switch operatively coupled with the color scanner and configured when actuated to cause the color reader to emit the color scanning beam;
a power source operatively coupled with one or both of the barcode scanner and the color scanner; and
an audio output device operatively coupled with one or both of the barcode scanner and the color scanner and configured to produce a user-audible output including information relevant to a scanned item.
